(19) United States
(12) Patent Application Publication
(10) Pub. No.: US 2013/0121908 A1
(43) Pub. Date: May 16, 2013

(54) METHOD FOR PRODUCING TRICHLOROSILANE WITH REDUCED BORON COMPOUND IMPURITIES

(71) Applicants: Mitsubishi Polycrystalline Silicon America Corporation (MIPSA), Theodore, AL (US); MITSUBISHI MATERIALS CORPORATION, Tokyo (JP)

(72) Inventors: Takeshi Kamei, Theodore, AL (US); Laura Prine, Theodore, AL (US); Takamasa Yasukawa, Yokkaichi-shi (JP); Yasuhiro Oda, Yokkaichi-shi (JP)

(73) Assignees: MITSUBISHI MATERIALS CORPORATION, Tokyo (JP); Mitsubishi Polycrystalline Silicon America Corporation (MIPSA), Theodore, AL (US)

(21) Appl. No.: 13/729,882

(22) Filed: Dec. 28, 2012

Related U.S. Application Data
(63) Continuation-in-part of application No. 12/896,116, filed on Oct. 1, 2010, now abandoned.

(51) Int. Cl. C01B 33/107

(52) U.S. Cl. CPC C01B 33/10763
USPC 423/342

(57) ABSTRACT

The present invention relates to a method for producing trichlorosilane having a reduced amount of boron compounds. The method including: (A) reacting metallurgical grade silicon with hydrogen chloride in a fluidized-bed reactor to produce a reaction gas including trichlorosilane; (B) first distilling the reaction gas, for separating first vapor fractions and first residue fractions, by setting a distillation temperature at a top of a distillation column between about a boiling point of trichlorosilane and about a boiling point of tetrachlorosilane and feeding the first vapor fractions to a second distillation column; (C) second distilling, for separating the trichlorosilane and second vapor fractions including boron compounds, by setting a distillation temperature at a top of the distillation column between about a boiling point of dichlorosilane and about a boiling point of trichlorosilane; and (D) feeding back the second vapor fractions to the fluidized-bed reactor.

### BACKGROUND OF THE INVENTION

1. Field of the Invention

The present invention relates to a method for producing trichlorosilane with less boron compound impurities, converting low boiling point boron compounds to high boiling point boron compounds, and reusing dichlorosilane, in a process of reacting metallurgical grade silicon with hydrogen chloride gas, thereby producing a reaction gas including trichlorosilane. The reaction gas is then distilled by at least two distillation processes.

2. Description of Related Art

Trichlorosilane (SiHCl₃, abbreviated “TCS”, boiling point: 31.8° C.), used as a raw material for producing high purity polycrystalline silicon, is produced by reacting metallurgical grade silicon powder (abbreviated “Me—Si”) of about 98% purity, which includes boron impurities, with hydrogen chloride gas (abbreviated “HCl”). Because other reactants are also produced in the reaction, a distillation process follows the reaction of TCS and HCl.

Trichlorosilane is purified by the distilling process. However, it is very difficult to separate trichlorosilane and boron compounds, produced in the reaction, which have low boiling points like diborane (B₂H₆) (boiling point: −92.5° C.), boron trichloride (BCl₃) (boiling point: 12.4° C.), tetraborane (B₄H₁₀) (boiling point: 18° C.), etc., by commercial distillation processes, because the boiling point of many boron compounds are close to or lower than that of TCS. Boron is included in metallurgical grade silicon powder as an unavoidable impurity. Several different boron compounds are created in the TCS and HCl reaction.

Some methods for producing trichlorosilane are proposed for removing boron compounds, for example as disclosed in Japanese Unexamined Patent Application Publication No, 2005-67979. The application proposes a method in which an ether group is added to an unpurified chlorosilane, then the unpurified chlorosilane is distilled. However, ether group recovery followed by refining is necessary. Further, U.S. Pat. No. 4,713,230 proposes a process for purification of trichlorosilane in which the vapor phase trichlorosilane, contaminated with boron compounds, is passed through a bed of silica. But a fixed bed of silica is required to maintain the cleaning of the silica.

One object of this invention is to provide a method for producing trichlorosilane which removes boron compounds from trichlorosilane. Another object of this invention is to effectively reuse dichlorosilane and other compounds by converting such reusable compounds into trichlorosilane.

### SUMMARY OF THE INVENTION

This invention relates to a method for producing trichlorosilane having a reduced amount of boron compounds, the method comprising (A) reacting metallurgical grade silicon with hydrogen chloride in a fluidized-bed reactor to produce a reaction gas including trichlorosilane; (B) first distilling the reaction gas, for separating first vapor fractions and first residue fractions, by setting a distillation temperature at a top of a distillation column between about a boiling point of trichlorosilane and about a boiling point of tetrachlorosilane and feeding the first vapor fractions to a second distillation column; (C) second distilling, for separating the trichlorosilane and second vapor fractions including boron compounds, by setting a distillation temperature at a top of the distillation column between about a boiling point of dichlorosilane and about a boiling point of trichlorosilane; and (D) feeding back the second vapor fractions to the fluidized-bed reactor.

In reacting metallurgical grade silicon with hydrogen chloride, a reaction gas including trichlorosilane is produced by reacting, in a fluidized-bed reactor, metallurgical grade silicon powders having more than 98 wt % purity with hydrogen chloride gas and a recycle stream of low boiling point boron compounds, trichlorosilane and dichlorosilane (abbreviated “DCS”, boiling point: 8.4° C.) from a distillation process, as described below. It is effective for stimulating a reaction between the metallurgical grade silicon powder and the hydrogen chloride gas to uniformly disperse hydrogen chloride gas in the fluidized-bed reactor. The fluidized-bed reactor is set at a reaction temperature between about 280° C. (536° F.) and about 320° C. (608° F.). The reaction gas produced in the fluidized-bed reactor is fed to a chiller for condensation. Then, the condensed liquid is fed to a first distillation column and a second distillation column.

Next, in the first distilling process, a distillation temperature at a top of a first distillation column is set between about a boiling point of trichlorosilane and about a boiling point of tetrachlorosilane. More specifically, the temperature at the top of the first distillation column, at 80 kPa (gauge pressure), is set between about 45° C. (113° F.) and about 55° C. (131° F.). Boron compounds having a high boiling point, tetrachlorosilane (SiCl₄, abbreviated “STC”, boiling point: 57.6° C.), polymer and a small amount of TCS as “Bottoms”, are separated in the distillation process. The vapor distillates from the process include boron compounds having a low boiling point or low boiling temperature, TCS, and a small amount of DCS. The vapor distillates are fed to a second distilling process as first vapor fractions.

After that, in the second distilling process, a distillation temperature at a top of a distillation column is set between about a boiling point of dichlorosilane and about the boiling point of trichlorosilane. Preferably, the temperature at a top of a second distillation column is set between about 50° C. (122° F.) and about 60° C. (140° F.), at 123 kPa (gauge pressure). Pure trichlorosilane is separated from the first vapor fractions by distillation. Boron compounds having a low boiling point, DCS and a little TCS are separated as second vapor distillates.

Further, the second vapor distillates are fed back to the fluidized-bed reactor, after they are vaporized by a vaporizer. By this process, boron compounds having a lower boiling point convert to higher boiling point boron compounds. For example, tetraborane (10) (B₄H₁₀) will convert to diborane (B₂H₆) and decaborane (B₁₀H₁₄). Diborane (B₂H₆) will convert to decaborane (B₁₀H₁₄). Tetraborane has a low boiling point, 18° C. (64° F.), and diborane has a low boiling point, −92.5° C. (−134.5° F.). However, decaborane has a high boiling point, 213° C. (415° F.). Decaborane is a stable material, so that the conversion reactions are hardly reversible.

This invention is based on this new discovery. In other words, boron compounds having low boiling points can be converted to high boiling point boron compounds and removed from the trichlorosilane production process. The inventors achieved the conversion of low boiling point boron compounds to high boiling point boron compounds by repeatedly separating and recycling back low boiling point boron compounds in the form of a gas (vapor fractions) to the fluidized-bed reactor (chlorinator) from the distillation columns. The high boiling point boron compounds can be removed in the residue fractions of the distillation columns.

### BRIEF DESCRIPTION OF THE DRAWINGS

FIG. 1 is a process flow diagram illustrating one embodiment of the invention; and

FIG. 2 is a process flow diagram illustrating another embodiment of the invention; and

FIG. 3 is a process flow diagram illustrating a further embodiment of the invention.

### DETAILED DESCRIPTION OF THE INVENTION

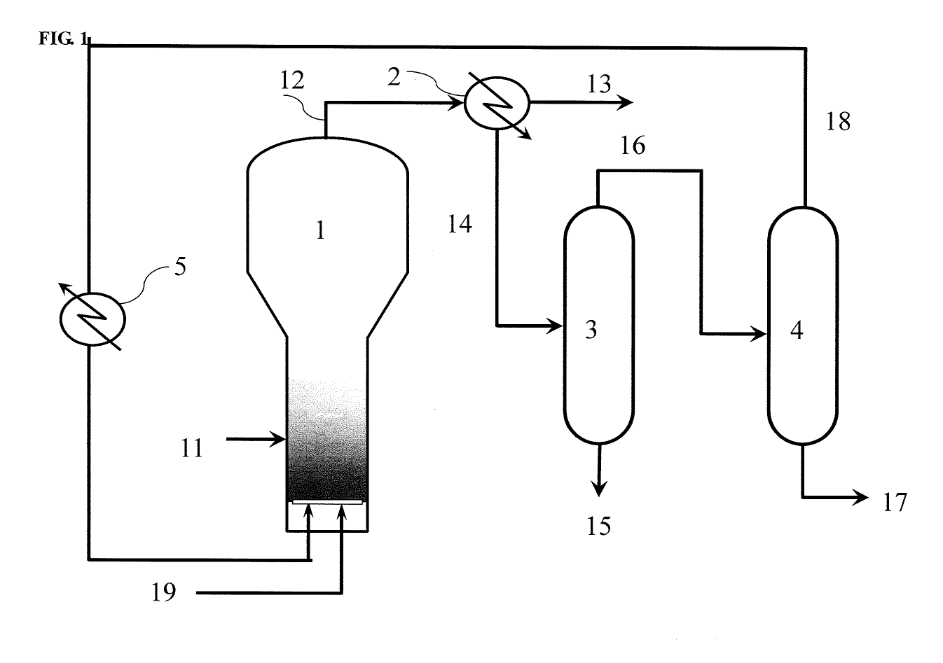

This invention produces purified trichlorosilane. Especially, this invention provides a method for reducing boron impurities which contaminate trichlorosilane. FIG. 1 shows a process flow diagram of a first embodiment. This invention comprises a fluidized-bed reactor 1, a chiller 2, a first distillation column 3, a second distillation column 4 and a vaporizer 5 connected to each other as shown in the figure.

The fluidized-bed reactor 1 is for reacting a metallurgical grade silicon powder (Me—Si) 11 of about 98% purity with a hydrogen chloride gas (HCI) 19, based on following reaction formula:

Si+3HCl→SiHCl₃+H₂ (1)

As a result of the Me—Si and HCl reaction, a reaction gas is produced in the fluidized-bed reactor 1. The reaction gas includes TCS, STC, DCS and boron compounds. The typical yield of reactants after chlorination in the fluidized-bed reactor is approximately the following: TCS at 88 wt %, STC at 11.5 wt %, DCS at 0.5 wt % and boron at 3,000 to 6,000 ppbwt. More specifically, TCS is included at more than 80 wt %. In this embodiment, a fluidized-bed type reactor is used. The metallurgical grade silicon powder 11 is continuously fed to the fluidized-bed reactor 1. The hydrogen chloride gas 19 is fed to the fluidized-bed reactor 1 from a bottom thereof and is reacted with the metallurgical grade silicon powder 11 while the hydrogen chloride gas 19 passes through the metallurgical grade silicon powder 11. A bed temperature of the fluidized-bed reactor 1 is set between about 280° C. and about 320° C. This range of temperature is selected for producing TCS effectively. Temperatures especially over 320° C. (608° F.) are not favorable for creating a ratio of TCS. A reaction gas 12 is fed to the chiller 2 for making a condensate 14. Unreacted hydrogen chloride gas and hydrogen gas are removed from this process as vent gases 13.

The condensate 14, which is cooled in the chiller 2, is fed to the middle of the first distillation column 3. At least one purpose of this first distillation column 3 is to remove high boiling point chemical compounds which have a boiling point greater than TCS. The first distillation column 3 mainly removes STC and high boiling boron compounds, etc. as first residue fraction 15; but it is acceptable that TCS is actually included in the first residue fraction 15 as well. The composition of the first residue fraction 15 is TCS at 30 wt %, boron at 322,000 ppbwt, and the balance STC and inevitable impurities. The high boiling point boron compounds include pentaborane (9) (B₅H₉), pentaborane (11) (B₅H₁₁), diboron tetrachloride (B₂Cl₄), hexaborane (B₆H₁₀), and decaborane (B₁₀H₁₄), etc.

The first distillation column 3 has a reboiler (not shown) which heats the first residue fraction 15, which may be one or more individual residue fractions, and refluxes a part of the first residue fraction 15 to the bottom of the first distillation column 3, and a condenser (not shown) which cools a first vapor fraction 16, which may be one or more individual vapor fractions, and refluxes the vapor fraction 16 to the top of the first distillation column 3.

A top temperature of the first distillation column 3 is set between about the boiling point of trichlorosilane and about the boiling point of tetrachlorosilane and is controlled by distillation pressure, throughput, and volume of the vapor fractions. In this embodiment, a distillation pressure in a top of the first distillation column 3 is set between about 70 kPag (10 psig) and 120 kPag (17 psig). When the temperature at the top of the first distillation column is lower than about the boiling point of TCS, it is not preferable because TCS, which is included in the first residue fraction 15, is increasing. On the other hand, when the temperature is greater than about the boiling point of STC, it is not preferable because high boiling point boron compounds and STC are included in the first vapor fraction 16. More preferably, the top temperature thereof is set between about 45° C. (113° F.) and about 55° C. (131° F.) at 80 kPa (gauge pressure). First vapor fraction 16 from the first distillation column 3 includes TCS, DCS and low boiling temperature boron compounds and is fed to the middle of second distillation column 4. Favorable bottom temperature of the first distillation column 3 is between about 65° C. (149° F.) and about 85° C. (185° F.) at 80 kPa (gauge pressure). The top temperature is controlled by a reflux rate of the first vapor fraction 16.

At least one purpose of the second distillation column 4 is to remove the low boiling point boron compounds as a second vapor fraction 18. The low boiling point boron compounds include diborane (B₂H₆), boron trichloride (BCl₃), tetraborane (B₄H₁₀). Industrially, it is acceptable that a little TCS and DCS are included in the second vapor fraction 18. On the other hand, purified trichlorosilane is separated as one of the second residue fractions 17. The purified trichlorosilane is used in many industries as a raw material. Especially, the polycrystalline silicon manufacturing industry uses the purified TCS as a raw material. For separating TCS, a top temperature of the second distillation column 4 is set between about a boiling point of DCS and about the boiling point of TCS. The top temperature of the second distillation column 4 is controlled by distillation column pressure, throughput, and reflux rate. A distillation pressure in a top of a second distillation column is set between about 100 kPag (15 psig) and 200 kPag (30 psig). When the temperature thereof is lower than about a boiling point of DCS, it is not preferable because low boiling point boron compounds are included in the second residue fractions 17. On the contrary, when the temperature is greater than about the boiling point of TCS, it is not preferable because it may be a sign of a flooding problem.

The second distillation column 4 has a reboiler (not shown) which heats the second residue fractions 17, which may be one or more individual residue fractions, and refluxes a part of the second residue fractions 17 to the bottom of the distillation column 4, and a condenser (not shown) which cools the second vapor fractions 18, which may be one or more individual vapor fractions, and refluxes the vapor fractions 18 to the top of the distillation column 4, as well as the first distillation column 3.

The second vapor fractions 18 from the second distillation column 4 include low temperature boiling boron compounds which are concentrated by the first distillation column 3 and the second distillation column 4. The second vapor fractions 18 composition contains boron at 2,000 ppbwt, DCS at 20-40 wt %, the balance TCS and inevitable impurities. More preferably, the second vapor fractions 18 include boron at more than 100 ppbwt. The second vapor fractions 18 include not only the low boiling point boron compounds, but also TCS and DCS, and are fed to the vaporizer 5. TCS and DCS are reused effectively in this process. DCS is converted to TCS in the fluidized-bed reactor 1 by repeatedly feeding back to the fluidized-bed reactor 1. The second vapor fractions 18 are vaporized in the vaporizer 5 and are fed back to the fluidized-bed reactor 1. This embodiment shows the first distillation column 3 and the second distillation column 4, but it is acceptable to provide one or more additional distillation columns in a series.

The low boiling point boron compounds convert to the high boiling temperature boron compounds by repeatedly feeding back low boiling point boron compounds from the second distillation column 4 to the fluidized-bed reactor 1. Low boiling point boron compounds, diborane (B₂H₆), tetraborane (10) (B₄H₁₀), etc. will finally convert to decaborane (B₁₀H₁₄). For example, diborane (B₂H₆) is reacted in according to the reaction formula:

5B₂H₆→B₁₀H₁₄+8H₂ (2)

In this reaction, Kc (chemical equilibrium constant) is 3.6×10¹², and since Kc is large, decaborane will never return back to diborane. The high boiling point boron compounds will be removed at the chiller 2 as a vent gas or will be separated at the first distillation column 3 as the first residue fractions 15.

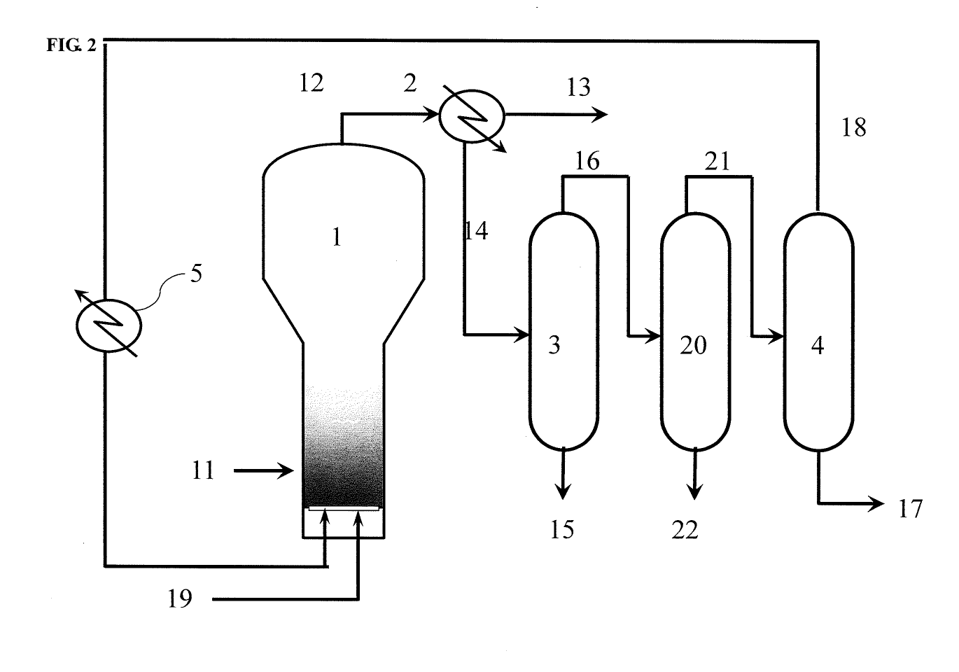

FIG. 2 shows a second embodiment. The difference between the first embodiment and second embodiment is an intermediate distillation column 20. The other elements are the same and use the same reference numbers. For concentrating the low boiling point boron compounds, it is more favorable that at least one more intermediate distillation columns 20 is provided between the first distillation column 3 and the second distillation column 4. At least one purpose of this intermediate distillation column 20 is to remove high boiling point chemical compounds which have a boiling point greater than trichlorosilane. The intermediate distillation column 20 mainly removes STC, high boiling boron compounds, etc. as a residue fraction 22, which may be one or more individual residue fractions, but it is acceptable that some amount of TCS is actually included in the residue fraction 22.

The intermediate distillation column 20 is operated under almost the same conditions as the first distillation column 3, except for a top temperature thereof. The top temperature of the intermediate distillation column 20 is preferably set between the top temperature of the first distillation column 3 and the boiling point of tetrachlorosilane. A vapor fraction 21, which may be one or more individual vapor fractions, of the intermediate distillation column 20 is fed to the middle of second distillation column 4. This embodiment shows one intermediate distillation column 20, but it is not so limited. It is acceptable to provide two or more intermediate distillation columns between the first distillation column 3 and the second distillation column 4.

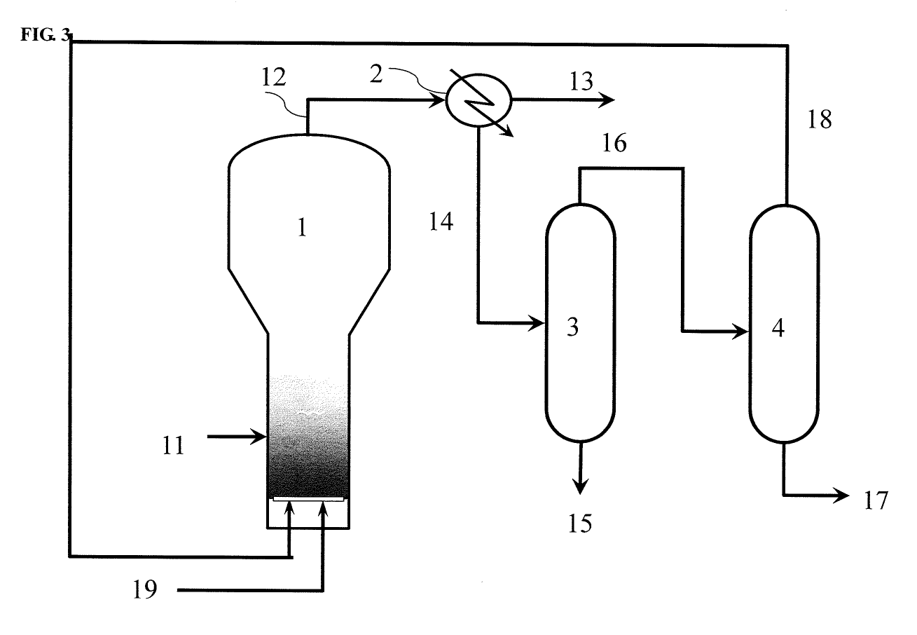

FIG. 3 shows a third embodiment. The difference between the first embodiment and third embodiment is the direct feed of the second vapor fractions 18 back to the fluidized-bed reactor 1. The other elements are the same and use the same reference numbers. For concentrating the low boiling point boron compounds efficiently, it is more favorable that the second vapor fractions 18 are fed back to the fluidized-bed reactor 1 directly, excluding any and all extra steps. For example the second vapor fractions 18 are fed back to the fluidized-bed reactor 1 without a vaporizer or other process device between the second distillation column 4 and the fluidized-bed reactor 1. The second vapor fractions 18 travel uninterrupted in pipes between the second distillation column 4 and the fluidized-bed reactor 1. This embodiment simplifies the process of converting low boiling point boron compounds to high boiling point boron compounds, and reusing dichlorosilane, in a process producing a high purity reaction gas including trichlorosilane.

### Example

Table 1 shows a content of boron contaminated in the second residue fraction, where the second vapor fraction feeds back to the fluidized-bed reactor and does not feed back to the fluidized-bed reactor after 10 hours has passed from the start of the reaction. This is based on the first embodiment.

Conditions of purity of metallurgical grade silicon powder, top temperature and bottom temperature of the first column, and top temperature and bottom temperature of the second column are as follows:

| | |
|---|---|
| Purity of metallurgical grade silicon powder | 98.57 wt % |
| Top temperature of the first distillation column | 49.4° C. (121° F.) |
| Bottom temperature of the first distillation column | 77.2° C. (171° F.) |
| Top temperature of the second distillation column | 55.5° C. (132° F.) |
| Bottom temperature of the second distillation column | 66.7° C. (152° F.) |
| Gauge pressure of the first distillation column | 79.3 kPa (11.5 psig) |
| Gauge pressure of the second distillation column | 123.4 kPa (17.9 psig) |

TABLE 1
Content of Boron (ppbwt)

| | |
|---|---|
| Second vapor fraction fed back | 178 ppbwt |
| to the fluidized-bed reactor | |
| Second vapor fraction not fed back | 2,215 ppbwt |
| to the fluidized-bed reactor | |

In this embodiment, the content of boron in the second residue fraction is measured by the Methylene blue absorptiometry. Triphenylchloromethane is used as the collection medium. 1,2-dichloroethane is used as an extractant.

The embodiments and examples are described for illustrative, but not limitative purposes. It is to be understood that changes and/or modifications can be made by those skilled in the art without for this departing from the related scope of protection, as defined by the enclosed claims.

What is claimed is:

1. A method for manufacturing trichlorosilane with reduced boron compounds, comprising:
reacting metallurgical grade silicon with hydrogen chloride, in a fluidized-bed reactor, to produce a reaction gas including trichlorosilane;
first distilling the reaction gas, for separating first vapor fractions and first residue fractions, by setting a distillation temperature at a top of a first distillation column between about a boiling point of trichlorosilane and about a boiling point of tetrachlorosilane;
feeding the first vapor fractions to a second distillation column;
second distilling, for separating the trichlorosilane and second vapor fractions including boron compounds, by setting a distillation temperature at a top of the second distillation column between about a boiling point of dichlorosilane and about the boiling point of trichlorosilane; and
feeding back the second vapor fractions to the fluidized-bed reactor directly.

2. The method for manufacturing trichlorosilane with reduced boron compounds according to claim 1, wherein the second vapor fractions are fed to a vaporizer before entering the fluidized-bed reactor.

3. The method for manufacturing trichlorosilane with reduced boron compounds according to claim 1, wherein a bed temperature of the fluidized-bed reactor is set between about 280° C. and about 320° C.

4. The method for manufacturing trichlorosilane with reduced boron compounds according to claim 1, wherein a condensate from the fluidized-bed reactor is cooled in a chiller before being fed to the middle of the first distillation column.

5. The method for manufacturing trichlorosilane with reduced boron compounds according to claim 1, wherein a distillation pressure in a top of the first distillation column is set between about 70 kPag (10 psig) and 120 kPag (17 psig).

6. The method for manufacturing trichlorosilane with reduced boron compounds according to claim 1, wherein a top temperature of the first distillation column is set between about 45° C. and about 55° C. at 80 kPa.

7. The method for manufacturing trichlorosilane with reduced boron compounds according to claim 1, wherein a bottom temperature of the first distillation column is between about 65° C. and about 85° C. at 80 kPa.

8. The method for manufacturing trichlorosilane with reduced boron compounds according to claim 1, wherein a top temperature in the first distillation column is controlled by a reflux rate of a first vapor fraction.

9. The method for manufacturing trichlorosilane with reduced boron compounds according to claim 1, wherein a composition of a first residue fractions from the first distillation column includes the following: TCS at 30 wt %, boron at 322,000 ppbwt, with a balance being STC and inevitable impurities.

10. The method for manufacturing trichlorosilane with reduced boron compounds according to claim 1, wherein a distillation pressure in a top of the second distillation column is set between about 100 kPag (15 psig) and 200 kPag (30 psig).

11. The method for manufacturing trichlorosilane with reduced boron compounds according to claim 1, wherein a top temperature of the second distillation column is controlled by a distillation column pressure, a throughput, and a reflux rate.

12. The method for manufacturing trichlorosilane with reduced boron compounds according to claim 1, wherein a second vapor fraction composition from the second distillation column includes the following: boron at 2,000 ppbwt, DCS at 20-40 wt %, with a balance being TCS and inevitable impurities.

13. The method for manufacturing trichlorosilane with reduced boron compounds according to claim 1, wherein the second vapor fraction includes boron at more than 100 ppbwt.

14. The method for manufacturing trichlorosilane with reduced boron compounds according to claim 1, wherein the first vapor fraction and second vapor fraction includes boron compounds having a low boiling point, TCS, and a small amount of DCS.

15. A method for manufacturing trichlorosilane with reduced boron compounds, comprising:
reacting metallurgical grade silicon with hydrogen chloride, in a fluidized-bed reactor with a bed temperature set between about 280° C. and about 320° C., to produce a reaction gas including trichlorosilane;
first distilling the reaction gas, for separating first vapor fractions and first residue fractions, by setting a distillation temperature at a top of a first distillation column between about a boiling point of trichlorosilane and about a boiling point of tetrachlorosilane, and setting a distillation pressure in the top of the first distillation column between about 70 kPag (10 psig) and 120 kPag (17 psig);
feeding the first vapor fractions to a second distillation column;
second distilling, for separating the trichlorosilane and second vapor fractions including boron compounds, by setting a distillation temperature at a top of the second distillation column between about a boiling point of dichlorosilane and about the boiling point of trichlorosilane, and setting a distillation pressure in the top of the second distillation column between about 100 kPag (15 psig) and 200 kPag (30 psig); and
feeding back the second vapor fractions to the fluidized-bed reactor directly.

16. A method for manufacturing trichlorosilane with reduced boron compounds, comprising:
reacting metallurgical grade silicon with hydrogen chloride, in a fluidized-bed reactor, to produce a reaction gas including trichlorosilane;
first distilling the reaction gas, for separating first vapor fractions and first residue fractions, by setting a distillation temperature at a top of a first distillation column between about a boiling point of trichlorosilane and about a boiling point of tetrachlorosilane;
feeding the first vapor fractions to an intermediate distillation column;
intermediate distilling, for separating intermediate vapor fractions and residue fractions, by setting a distillation temperature at a top of the intermediate distillation column between about a boiling point of the first distillation column and the boiling point of tetrachlorosilane;
feeding the intermediate vapor fractions to a second distillation column;
second distilling, for separating the trichlorosilane and second vapor fractions including boron compounds, by setting a distillation temperature at a top of the second distillation column between about a boiling point of dichlorosilane and about the boiling point of trichlorosilane; and
feeding back the second vapor fractions to the fluidized-bed reactor directly.

17. The method for manufacturing trichlorosilane with reduced boron compounds according to claim 15, wherein the second vapor fractions include low boiling point boron compounds of diborane (B₂H₆), boron trichloride (BCl₃) and tetraborane (B₄H₁₀).
